(19) United States
(12) Patent Application Publication
(10) Pub. No.: US 2007/0115692 A1
(43) Pub. Date: May 24, 2007

(54) Liquid crystal display having liquid crystal panel secured using micro-adhesive units

(75) Inventor: Yen-Chang Yao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/601,918

(22) Filed: Nov. 20, 2006

(30) Foreign Application Priority Data
Nov. 18, 2005 (TW) 94140630

(51) Int. Cl. F21V 7/04

(52) U.S. Cl. 362/632; 362/634

(57) ABSTRACT

An exemplary liquid crystal display (5) includes a backlight module (60) and a liquid crystal panel (50). The backlight module includes a frame (62) having a bonding part (627) with a plurality of micro adhesive units. The liquid crystal panel is adhered at the bonding part via the micro adhesive units.

### FIELD OF THE INVENTION

The present invention relates to liquid crystal displays, and more particularly to a liquid crystal display configured to provide strong bonding between a liquid crystal panel and a frame thereof.

### BACKGROUND

A common kind of liquid crystal display includes a liquid crystal panel, and a backlight module providing a planar light source for the liquid crystal panel. The liquid crystal panel is received and fixed within a frame of the backlight module by way of double-sided adhesive tape or similar means. Thereby, the liquid crystal panel is protected from external impact, and shifting of the liquid crystal panel relative to the backlight module is avoided.

Referring to FIG. 8, this shows a conventional liquid crystal display. The liquid crystal display 1 includes a liquid crystal panel 10, and a backlight module 20 providing a uniform planar light source for the liquid crystal panel 10.

The backlight module 20 includes a frame 22 having a receiving space, an optical film 21 having a plurality of protrusions formed on side edges thereof, a light guide plate 24 having a top emitting surface 241 and an opposite back surface 242, a reflective sheet 25, and a flexible printed circuit board 27 having a plurality of light sources 26 attached thereon. The receiving space of the frame 22 is cooperatively formed by first, second, third and fourth side walls 221, 222, 223, and 224 connected end-to-end. The side walls 221, 222, 223, and 224 include depressed supporting parts 2220 at inner sides thereof respectively. The supporting part 2220 of the second side wall 222 has a plurality of cutouts 2222. The supporting parts 2220 at the first, third, and fourth side walls 221, 223, and 224 include a plurality of coplanar bonding parts 227. The receiving space of the frame 22 is divided by the supporting parts 2220 into upper and lower receiving spaces 228, 229. Three gaps 2271, 2274 and 2275 are defined in the supporting members 227 at the first, third, and fourth side walls 221, 223, and 224 respectively.

A process of assembling the liquid crystal display 1 is as follows. Firstly, the light guide plate 24 is fittingly received in the lower receiving space 229 of the frame 22. The reflective sheet 25 is received in the lower receiving space 229 below the back surface 242 of the light guide plate 24. Secondly, the optical film 21 is received in the upper receiving space 228 of the frame 22 adjacent to the emitting surface 241 of the light guide plate 24, with the protrusions of the optical film 21 wedging in the gaps 2271, 2274, and 2275. Then, the flexible printed circuit board 27 is disposed on the supporting part 2220 of the second side wall 222, with the light sources 226 wedging in the cutouts 2222. Thirdly, the liquid crystal panel 10 is received in the upper receiving space 228 and fixed to the bonding parts 227 via a plurality of double-sided adhesive tapes 30.

The surfaces of the liquid crystal panel 10 to which the double-sided adhesive tapes 30 are attached are flat. Similarly, the surfaces of the supporting members 227 to which the double-sided adhesive tapes 30 are attached are also flat. The bonding strength between the respective surfaces is proportional to the contact areas of the surfaces. If the contact areas are too small, or if the liquid crystal display 1 is used in a rugged application or environment, the bonding strength may not be enough to securely and reliably fix the liquid crystal panel 10 to the supporting members 227. For example, if the liquid crystal display 1 is subjected to external impact or vibration, the liquid crystal panel 10 is liable to slide in the frame 22 or become dislodged from the frame 22. When this happens, the functioning of the liquid crystal display 1 may be impaired, and the liquid crystal panel 10 may sustain damage.

Accordingly, what is needed is a liquid crystal display configured to have a liquid crystal panel securely fixed relative to a backlight module thereof.

### SUMMARY

An exemplary liquid crystal display includes a backlight module and a light crystal panel. The backlight module includes a frame having a bonding part with a plurality of micro adhesive units, and the liquid crystal panel is adhered to the bonding part via the micro adhesive units.

A detailed description of embodiments of the present invention is given below with reference to the accompanying drawings.

### BRIEF DESCRIPTION OF THE DRAWINGS

In the drawings, all the views are schematic.

FIG. 1 is an exploded, isometric view of a liquid crystal display in accordance with a first embodiment of the present invention.

FIG. 2 is a view of a frame of the liquid crystal display of FIG. 1 shown in isolation.

FIG. 3 is an inverted, isometric view of the frame of FIG. 2.

FIG. 4 is an enlarged cross-sectional view of part of the frame of FIG. 2, taken along line IV-IV thereof.

FIG. 5 is a cross-sectional view of part of a frame of a liquid crystal display according to a second embodiment of the present invention.

FIG. 6 is a cross-sectional view of part of a frame of a liquid crystal display according to a third embodiment of the present invention.

FIG. 7 is a cross-sectional view of part of a frame of a liquid crystal display according to a fourth embodiment of the present invention.

FIG. 8 is an exploded, isometric view of a conventional liquid crystal display.

### DETAILED DESCRIPTION OF PREFERRED EMBODIMENTS

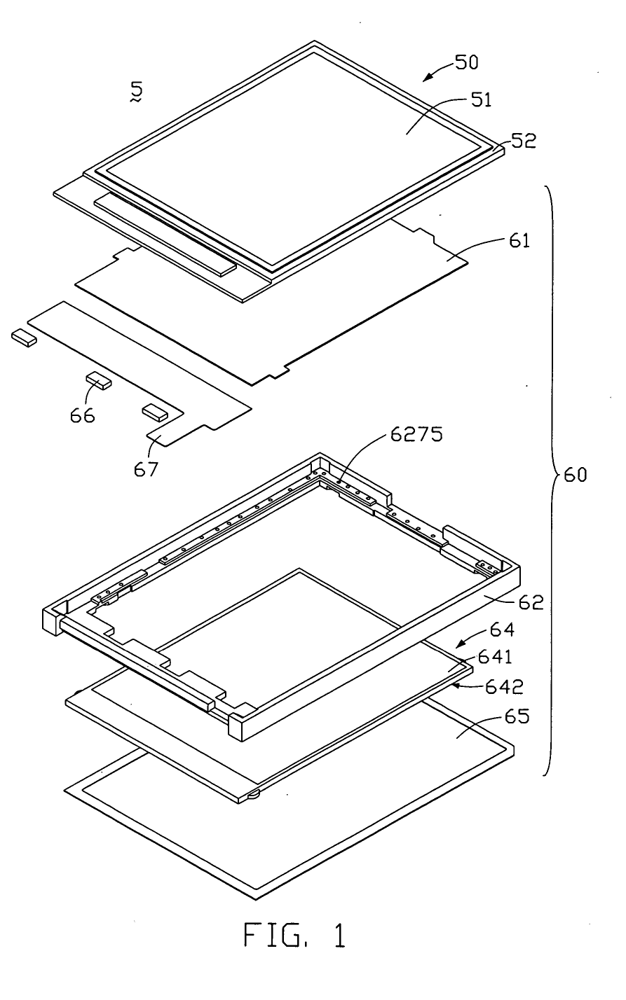

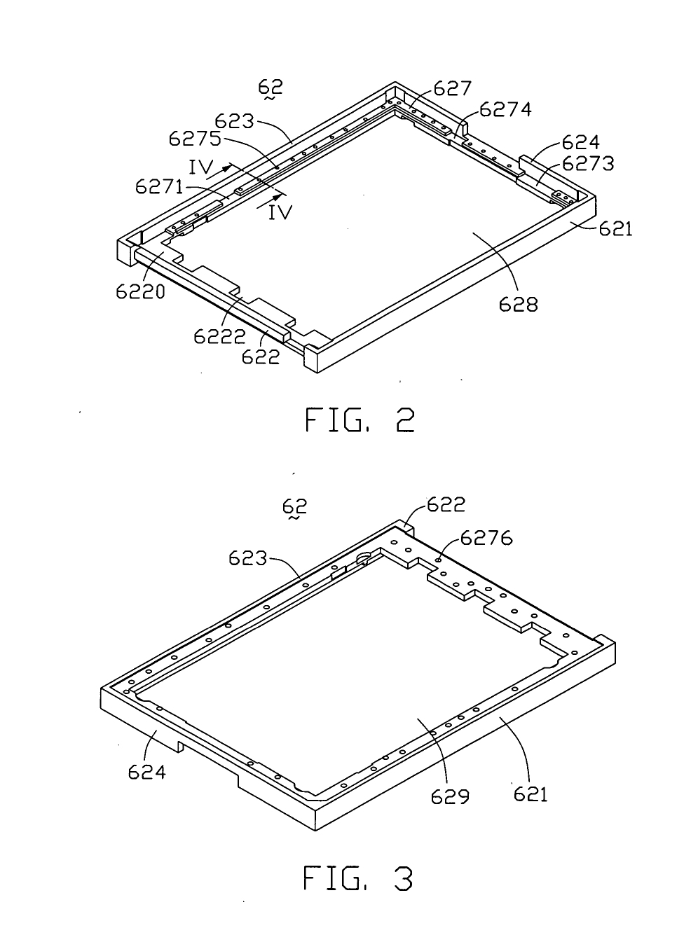

Referring to FIGS. 1 to 3, these show a liquid crystal display 5 in accordance with a first embodiment of the present invention. The liquid crystal display 5 includes a liquid crystal panel 50 having a display area 51 and a non-display area 52, and a backlight module 60 providing a uniform planar light source for the liquid crystal panel 50.

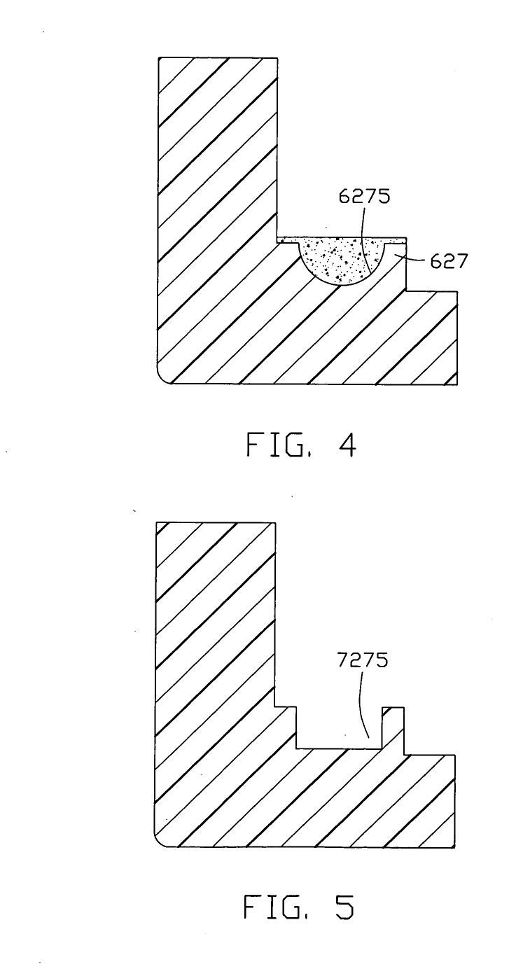

The backlight module 60 includes a frame 62 having a receiving space, an optical film 61 having a plurality of protrusions on side edge portions thereof, a light guide plate 64 having a top emitting surface 641 and an opposite back surface 642, a reflective sheet 65 having a reflective side (not labeled) and a back side (not labeled), and a flexible printed circuit board 67 having a plurality of light sources 66 attached thereon. The receiving space of the frame 62 is formed by first, second, third, and fourth side walls 621, 622, 623, and 624 connected end-to-end. The side walls 621, 622, 623, and 624 include depressed supporting parts 6220 at inner sides thereof respectively. The supporting part 6220 of the second side wall 622 has a plurality of concave parts 6222, and the supporting parts 6220 of the first, third, and fourth side walls 621, 623, and 624 include a plurality of bonding parts 627. The bonding parts 627 and back sides of the supporting parts 6220 have a plurality of micro adhesive units. The micro adhesive units can for example be concave pits such as hemispherical pits 6275, 6276, as shown in FIG. 4. The receiving space of the frame 62 is divided by the supporting parts 6220 into upper and lower receiving spaces 628, 629. Three gaps 6271, 6273, and 6274 are defined in the supporting members 627 at the first, third, and fourth side walls 621, 623, and 624 respectively.

A process of assembly of the liquid crystal display 5 is as follows. Firstly, the light guide plate 64 is received in the lower receiving space 629 of the frame 62. Secondly, the optical film 61 is disposed in the upper receiving space 628 of the frame 62 adjacent to the emitting surface 641 of the light guide plate 64, with the protrusions of the optical film 61 wedging in the gaps 6271, 6273, and 6274. Then the flexible printed circuit board 67 is disposed on the supporting part 6220 of the second side wall 622, with the light sources 626 wedging in the concave parts 6222. Thirdly, glue is coated on the bonding parts 627, with the glue also filling the hemispherical pits 6275 thereof. Similarly, glue is coated on the back sides of the supporting parts 6220, with the glue also filling the hemispherical pits 6276 thereof. Then the liquid crystal panel 50 is attached to the frame 62 adjacent to the optical film 61, by pressing the non-display area 52 of the liquid crystal panel 50 onto the bonding parts 627 adjacent to the optical film 61. Then the reflective sheet 65 is attached to the frame 62 such that the reflective side of the reflective sheet 65 is adjacent the back surface 642 of the light guide plate 61, by pressing the reflective sheet 65 onto the back sides of the supporting parts 6220. The glue is preferably pressure sensitive adhesive or double adhesive tape with liquid or semi-liquid adhesive.

Interface areas between the non-display area 52 of the liquid crystal panel 51 and the bonding parts 627 are increased by the hemispherical pits 6275, and interface areas between the reflective sheet 65 and the back sides of the supporting parts 6220 are increased by the hemispherical pits 6276. Therefore the bonding strength between the liquid crystal panel 51 and the frame 62 is increased, and the bonding strength between the reflective sheet 65 and the frame 62 is increased. Thus sliding of the liquid crystal panel 50 relative to the frame 62 can be avoided, and sliding of the reflective sheet 65 relative to the frame 62 can also be avoided.

Referring to FIG. 5, this is a cross-sectional view of part of a frame of a liquid crystal display according to a second embodiment of the present invention. The liquid crystal display of the second embodiment is similar to the above-described first embodiment. The liquid crystal display includes a plurality of supporting parts (not labeled) and a plurality of bonding portions (not labeled), each having a plurality of micro adhesive units. The micro adhesive units are rectangular pits 7275. That is, a side cross-section of each of the rectangular pits 7275 is rectangular. Interface areas where glue is applied are increased by the rectangular pits 7275.

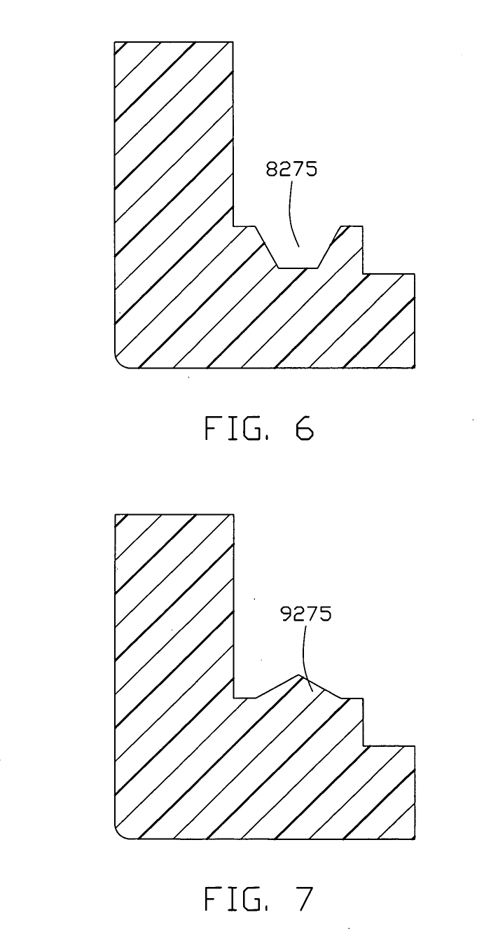

Referring to FIG. 6, this is a cross-sectional view of part of a frame of a liquid crystal display according to a third embodiment of the present invention. The liquid crystal display of the third embodiment is similar to the above-described first embodiment. The liquid crystal display includes a plurality of supporting parts (not labeled) and a plurality of bonding portions (not labeled), each having a plurality of micro adhesive units. The micro adhesive units are trapezoid-shaped pits 8275. That is, a side cross-section of each of the trapezoid-shaped pits 8275 is trapezoidal. Interface areas where glue is applied are increased by the trapezoid-shaped pits 8275.

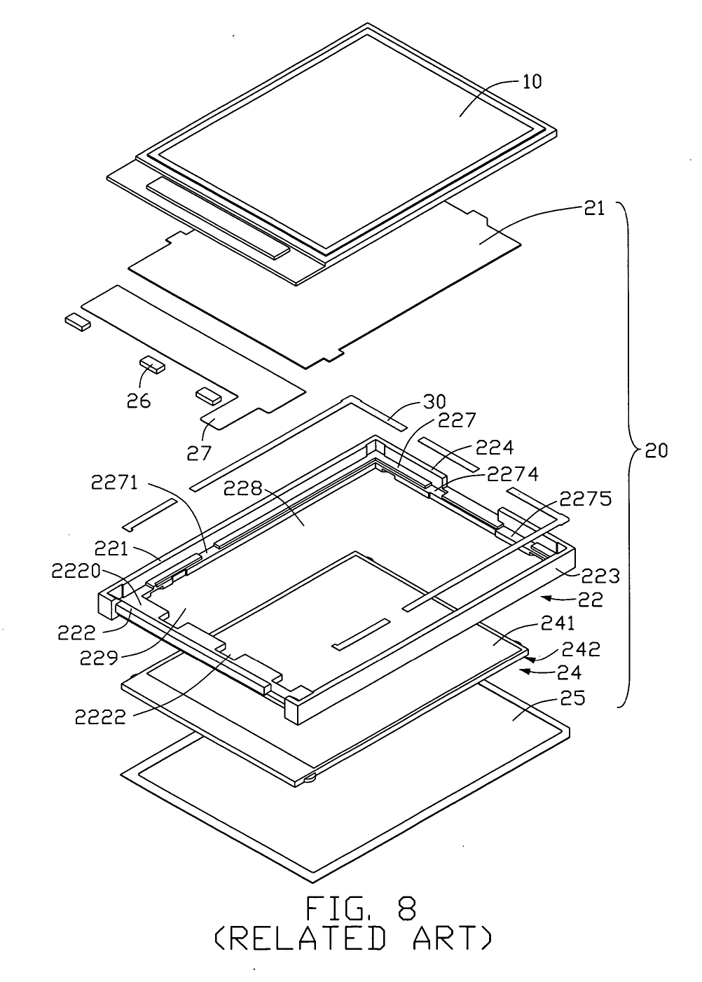

Referring to FIG. 7, this is a cross-sectional view of part of a frame of a liquid crystal display according to a fourth embodiment of the present invention. The liquid crystal display of the fourth embodiment is similar to the above-described first embodiment. The liquid crystal display includes a plurality of supporting parts (not labeled) and a plurality of bonding portions (not labeled), each having a plurality of micro adhesive units. The micro adhesive units are triangular protruding parts 9275. That is, a side cross-section of each of the protruding parts 9275 is triangular. Interface areas where glue is applied are increased by the triangular protruding parts 9275.

In alternative embodiments, any combination of the hemispherical pits 6275, 6276, rectangular pits 7275, trapezoid-shaped pits 8275, and the protruding parts 9275 can be employed in the one same liquid crystal display. The micro adhesive units are not limited to the above-described hemispherical pits 6275, 6276, rectangular pits 7275, trapezoid-shaped pits 8275, and the protruding parts 9275. The micro adhesive units can have any of various regular or irregular curved and/or rectilinear shapes and configurations, such as concavities or domes. The hemispherical pits 6275, 6276, rectangular pits 7275, trapezoid-shaped pits 8275, and the protruding parts 9275 can further or alternatively be formed on the non-display area 52 of the liquid crystal panel 50, and/or further or alternatively formed on a periphery of the reflective side of the reflective sheet 65. The hemispherical pits 6275, 6276, rectangular pits 7275, trapezoid-shaped pits 8275, and the protruding parts 9275 can be arranged linearly, or according to a predetermined pattern, or randomly.

While examples and preferred and exemplary embodiments have been described, it is to be understood that the invention is not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A liquid crystal display, comprising:
a backlight module comprising a frame having a bonding part with a plurality of micro adhesive units; and
a liquid crystal panel adhered to the bonding part via the micro adhesive units.

2. The liquid crystal display as claimed in claim 1, wherein the micro adhesive units comprise a plurality of pits formed in the bonding part.

3. The liquid crystal display as claimed in claim 1, wherein the micro adhesive units comprise a plurality of protruding parts formed on the bonding part.

4. The liquid crystal display as claimed in claim 1, wherein the liquid crystal panel comprises a supporting portion, and the supporting member comprises a plurality of micro adhesive units.

5. The liquid crystal display as claimed in claim 4, wherein the micro adhesive units comprise one or more items selected from the group consisting of one or more pits formed in the supporting portion, and one or more protruding parts formed on the supporting portion.

6. The liquid crystal display as claimed in claim 1, wherein the backlight module further comprises a light guide plate and a reflective sheet.

7. The liquid crystal display as claimed in claim 6, wherein the frame further comprises a supporting portion with a plurality of micro adhesive units, and the reflective sheet is adhered to the supporting portion via the micro adhesive units.

8. The liquid crystal display as claimed in claim 6, wherein the frame further comprises a supporting portion, the reflective sheet comprises a plurality of micro adhesive units, and the reflective sheet is adhered to the supporting portion via the micro adhesive units.

9. The liquid crystal display as claimed in claim 2, wherein the pits have shapes selected from the group consisting of hemispherical, rectangular in cross-section, trapezoidal in cross-section, and concave.

10. The liquid crystal display as claimed in claim 3, wherein the protruding parts have shapes selected from the group consisting of triangular in cross-section and dome-shaped.

11. The liquid crystal display as claimed in claim 4, wherein the micro adhesive units are selected from the group consisting of one or more pits and one or more protruding parts.

12. The liquid crystal display as claimed in claim 11, wherein the pits have shapes selected from the group consisting of hemispherical, rectangular in cross-section, trapezoidal in cross-section, and concave, and the protruding parts have shapes selected from the group consisting of triangular in cross-section and dome-shaped.

13. The liquid crystal display as claimed in claim 7, wherein the micro adhesive units are selected from the group consisting of one or more pits and one or more protruding parts.

14. The liquid crystal display as claimed in claim 13, wherein the pits have shapes selected from the group consisting of hemispherical, rectangular in cross-section, trapezoidal in cross-section, and concave, and the protruding parts have shapes selected from the group consisting of triangular in cross-section and dome-shaped.

15. A liquid crystal display, comprising:
a backlight module comprising a frame having a bonding part; and
a liquid crystal panel with a plurality of micro adhesive units adhered to the bonding part via the micro adhesive units.

16. The liquid crystal display as claimed in claim 15, wherein the micro adhesive units comprise a plurality of pits formed in the liquid crystal panel.

17. The liquid crystal display as claimed in claim 15, wherein the micro adhesive units comprise a plurality of protruding parts formed on the liquid crystal panel.

18. The liquid crystal display as claimed in claim 16, wherein the pits have shapes selected from the group consisting of hemispherical, rectangular in cross-section, trapezoidal in cross-section, and concave.

19. The liquid crystal display as claimed in claim 17, wherein the protruding parts have shapes selected from the group consisting of triangular in cross-section and dome-shaped.

20. A liquid crystal display comprising:
a backlight module including
a frame;
a liquid crystal panel defining a peripheral edge region in alignment with the frame in a vertical direction perpendicular to a plane defined by the liquid crystal plane; and
an adhesive units sandwiched between the frame and the peripheral edge region in said vertical direction; wherein
at least one interface between the frame and the adhesive units or between the peripheral edge region and the adhesive units, extends in a multiple planar assembly instead of a flat manner.
